(19) United States
(12) Patent Application Publication
(10) Pub. No.: US 2024/0406629 A1
(43) Pub. Date: Dec. 5, 2024

(54) AUDIO SPEAKER COORDINATION SYSTEM

(71) Applicant: Dolby Laboratories Licensing Corporation, San Francisco, CA (US)

(72) Inventors: Pengfei ZHOU, Shanghai (CN); Pengfeng ZHANG, Shanghai (CN); Mingyi Huang, Shenzhen (CN)

(73) Assignee: Dolby Laboratories Licensing Corporation, San Francisco, CA (US)

(21) Appl. No.: 18/696,944

(22) PCT Filed: Sep. 29, 2022
(86) PCT No.: PCT/US2022/045256

§ 371 Date: Mar. 28, 2024

Related U.S. Application Data
(60) Provisional application No. 63/272,362, filed on Oct. 27, 2021.

(30) Foreign Application Priority Data
Sep. 29, 2021 (WO) PCT/CN2021/121582

(51) Int. Cl. H04R 3/14

(52) U.S. Cl. CPC H04R 3/14; H04R 2420/01; H04R 2420/07; H04R 2420/09; H04R 2499/11; H04R 2499/15

(57) ABSTRACT

Novel methods and systems for coordinating sound to both internal and external speakers for a device is disclosed. The audio signal is distributed among the internal and external speakers and aligned so that signals going to the internal speakers are aligned with signals going to the external speakers.

### CROSS-REFERENCE TO RELATED APPLICATION

This application claims priority of the following priority applications: U.S. provisional application 63/272,362, filed 27 Oct. 2021, and PCT application PCT/CN2021/121582, filed 29 Sep. 2021.

### TECHNICAL FIELD

The present disclosure relates to improvements for utilizing multiple speakers. More particularly, it relates to methods and systems for coordinating a system's internal speakers with external speakers.

### BACKGROUND

Many devices have both internal speakers and the option to direct sound to external speakers, either through wired or wireless connection. In these systems, the usual options are to either toggle the sound between the internal and external speakers, so only one set of speakers is working at any given time, or to just pipe the sound equally (aside from some volume adjustments by the user) to both the internal and external speakers.

FIG. 1 shows an example of the above-mentioned system. The audio content (110) is decompressed by a codec (180) to be played by the device (190) using its internal speakers. External speakers (195) can also be connected to the device.

### SUMMARY

An enhancement to audio playback on devices having both internal and external speakers is presented herein. The audio signal is processed to distribute the signal between the internal and external speakers and the signals are aligned in time (timestamp).

An embodiment for achieving a method for enhancing an audio signal for a device with at least one internal speaker and at least one external speaker is presented, the method comprising: distributing the audio signal to the at least one internal speaker and the at least one external speaker; and aligning timestamps for the distributed audio signal such that signals for the at least one internal speaker aligns with signals for the at least one external speaker.

The method can be performed by a device that includes a processor. The method can be incorporated into a decoder of a device.

An embodiment for achieving a device is presented, the device comprising: an audio input; a microphone; at least one internal speaker; at least one connector for external speakers; a wireless communications module; and a processor; wherein the device is configured to: decode an audio signal from the audio input producing decoded audio; determine connection statuses of the external speakers both connected to the at least one connector and connected by wireless communications module; perform cooperative playback control based on the connection statuses; determine locations of the external speakers both connected to the at least one connector and connected by wireless communications module; perform dynamic adjustment for the external speakers based on the locations; perform multi-channel mixing based on the decoded audio, the cooperative playback control, and the dynamic adjustment producing a mixed signal; perform crossover configuration on the mixed signal producing a crossover signal; perform signal distribution on the crossover signal among the external speakers and internal speakers producing a distributed signal; and perform time alignment for the distributed signal for the external speakers and internal speakers.

The device can be configured to carry out these steps by use of software modules that perform these functions and/or by hardware/firmware designed to perform these functions.

### BRIEF DESCRIPTION OF DRAWINGS

FIG. 1 illustrates an example prior sound system.

FIG. 2 illustrates an example of a sound system with the coordinated speaker system.

FIG. 3 illustrates an example of the coordinated speaker system.

FIG. 4 illustrates an example graph of frequency response for external vs. internal speakers.

FIGS. 5A-5J illustrate examples of using the coordinated speaker system.

### DETAILED DESCRIPTION

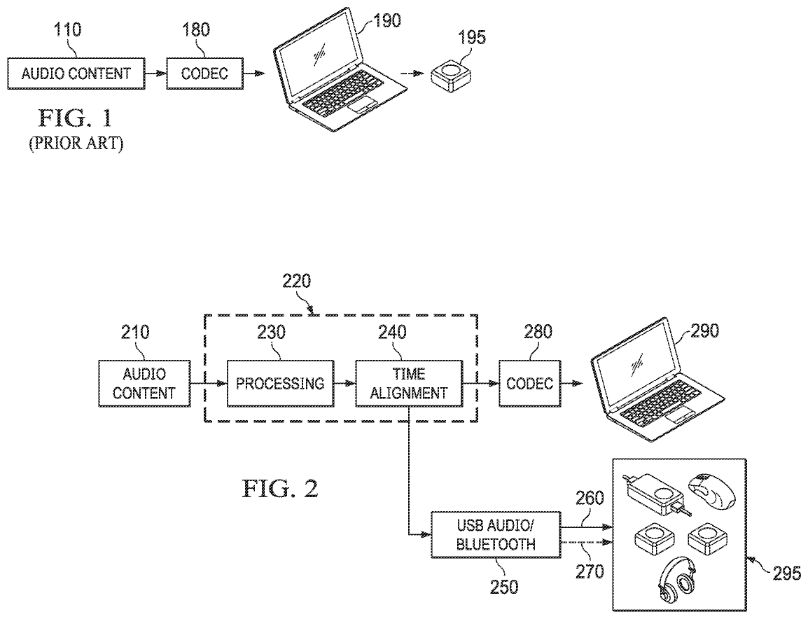

FIG. 2 shows an example system with coordinated sound. The audio content (210) is processed by the coordinated sound system (220) which includes a processing step (230) and a time alignment step (240) before being sent to the codec (280) for use by the internal speakers of the device (290) and sent to external USB, Bluetooth™, etc. (250) connections, wired 260 and/or wireless (270) to one or more external speaker devices (295). The coordinated sound system (220) can be integrated into the device (hardware, software, and/or firmware) or can be external to the device (e.g., USB plug-in).

As used herein, the term “device” refers to any electronic mechanism or system that is capable of outputting sound from digital audio content to one or more internal speakers and is also capable of outputting sound from digital audio content to one or more external speakers. Examples of devices include laptop computers, desktop computers, tablet computers, smartphones, television sets, etc.

As used herein, the term “audio content” refers to any digital media that contains audio content. This includes music, video, audiobook, voice recording, movies, television, streaming content, radio, live audio (microphone), etc.

As used herein, “speaker” refers to any audio playback sound generation device, such as a piezoelectric speaker, a headphone speaker, an earbud, a soundbar, a dynamic speaker, etc. Speakers can be full range, high range, mid-range, woofer, subwoofer, etc.

A speaker can also be integrated into another device, such as a power cord adapter or a computer mouse with an integrated transducer and supporting electronics. The data connection to the device can be wired or wireless and can piggy-back on an existing connection or be added as a new connection.

As used herein, “internal speaker” refers to a speaker that is either internal to or integrated with the device and that connects with the device's codec.

As used herein, “external speaker” refers to a speaker that is external to the device and receives the audio content through wired (USB, firewire, audio jack, etc.) or wireless (Bluetooth, etc.) connection to the device.

The “processing” (230) in the system (220) can include any audio processing for preparing the audio to be played on multiple speakers. For example, mixing, crossover, dynamic adjustment, etc. It can include systems to aid in controlling the multiple speakers. For example, detecting speaker connection, detecting speaker location, adjusting individual speaker use, adjusting individual speaker volume, etc. Speaker location can be determined, for example, by using the device's microphone to pick up the distance and direction of each speaker (either during use or by an automated audio test). Speaker location can also be determined by user input (e.g., through a graphical user interface of the device).

The “time alignment” (240) in the system (220) adjusts the delay for each speaker to create the desired immersive sound effect (e.g., surround sound) based on the speakers' locations.

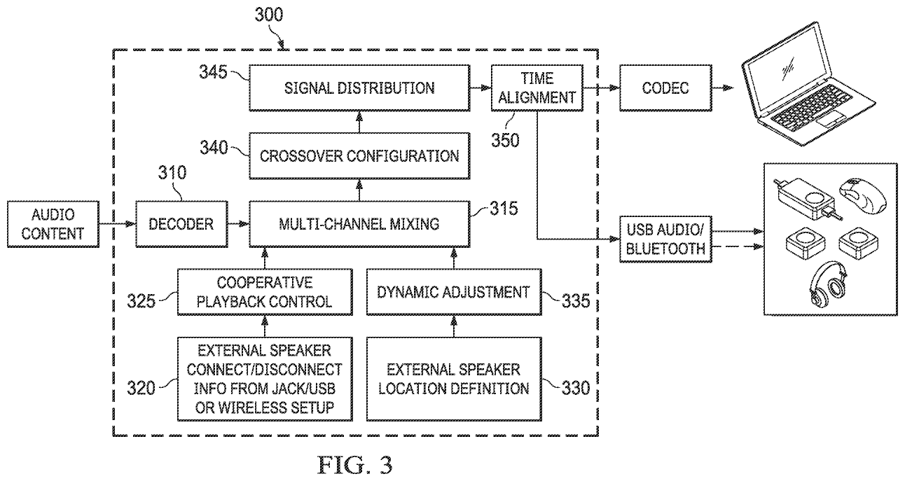

FIG. 3 shows an example coordination system (300). The system determines the connection status of the external speakers (320) by checking the device ports and wireless connections. This provides information for cooperative playback control (325) of the external speakers, which assigns channels to the speakers. The information for cooperative playback control at least includes if the external speaker is connected or not, the number of connected external speakers, the external speakers' acoustics performance (such as loudness, frequency response, bandwidth . . . all of which can be received by automatic measurement from the system, audio device built-in configuration parameters, and/or user input/definitions). The locations of the external speakers are determined (330) which provides input for the dynamic adjustment (335) of the speakers (e.g., based on estimated speaker distance and strength). These feed into multi-channel mixing (315) to divide up the channels among the speakers (M channels into N speakers, e.g., Dolby 7.1.2™). These go into a crossover configuration (340) which provides which frequency ranges go to which speakers. For example, the internal speakers might have poor quality in the lower frequency ranges, so they are given the higher and mid frequency audio while the external speakers get the lower frequencies. Or a speaker might be identified as a sub-woofer and so is allocated the appropriate frequency range. The signals are distributed (345) to the appropriate outputs (e.g., Dolby ATMOS™) and time aligned (350) based on speaker location and desired effects.

The cooperative playback control can detect/check if the external audio device is connected or not. In some embodiments, the user and/or manufacturer can define which speakers are enabled/disabled for cooperative use.

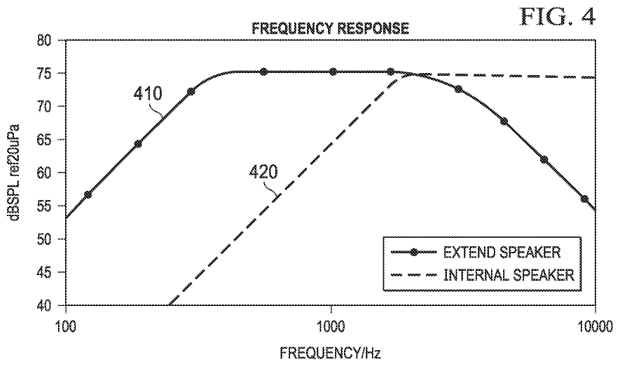

FIG. 4 shows a graph of example frequency responses between external (410) and internal (420) speakers. As shown, typically the internal speakers (420) perform better in mid to high frequencies (here 2K Hz and up) while the external speakers (410) have better low frequency response. This can change depending on the device and the type of external speakers, but for the usual case a crossover parameter that is based on the frequency responses of the speakers can give a better listening experience.

Signal distribution distributes the corresponding audio signals to the internal and external speakers separately.

The time alignment ensures that the internal and external speakers have the same timestamp during playback, being aligned with each other as well with any additional playback accompanying the audio (e.g., video).

The external speaker locations can be determined by user data (GUI input), operating system information (e.g., a right-hand mouse would be located in the front-right of the user), or by microphone recognition to define different multi-channel speakers.

Multichannel mixing can be adjusted based on the number of available speakers and the user case (e.g., Dolby 2.1, 2.2, 4.0, 6.0, 5.1.2, 7.1.2, etc.).

Dynamic adjustment can adjust the virtualizer and surround performance as the speaker locations change over time.

The system can be configured to provide several sound options for coordination. In some embodiments, the sound is split among the speakers based on frequency response. In some embodiments, the sound is split among the speakers based on dividing the channels. In some embodiments, the sound is split among the speakers to provide a surround sound effect. In some embodiments, the sound is split among the speakers based on a combination of two or more of these options.

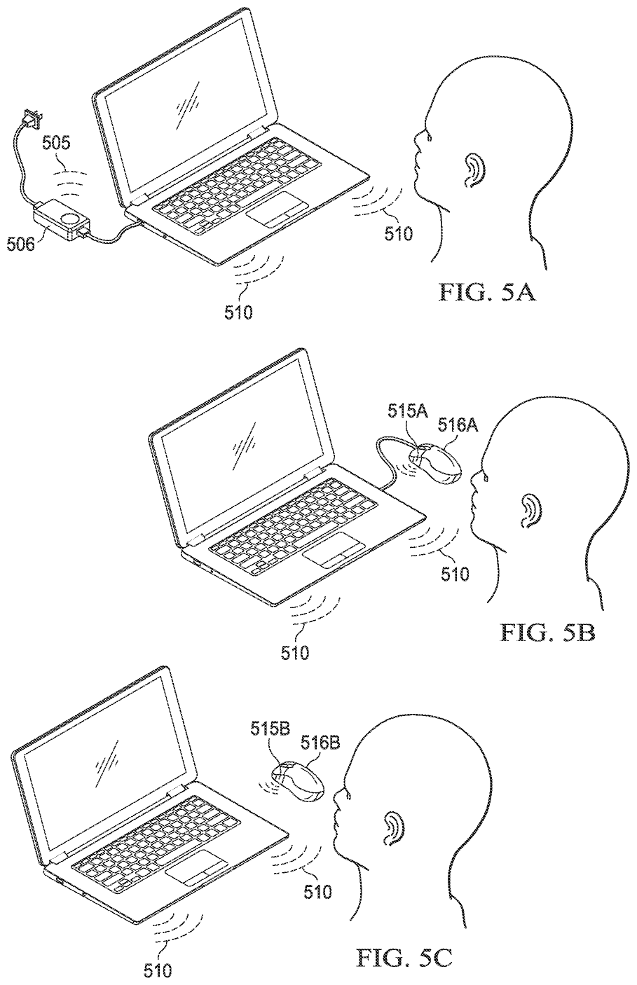

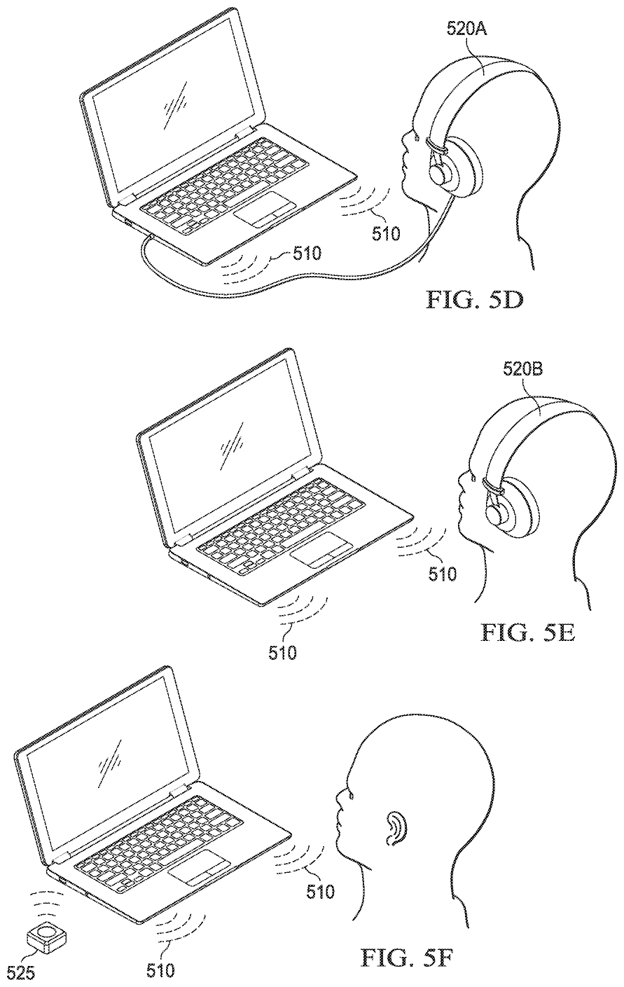

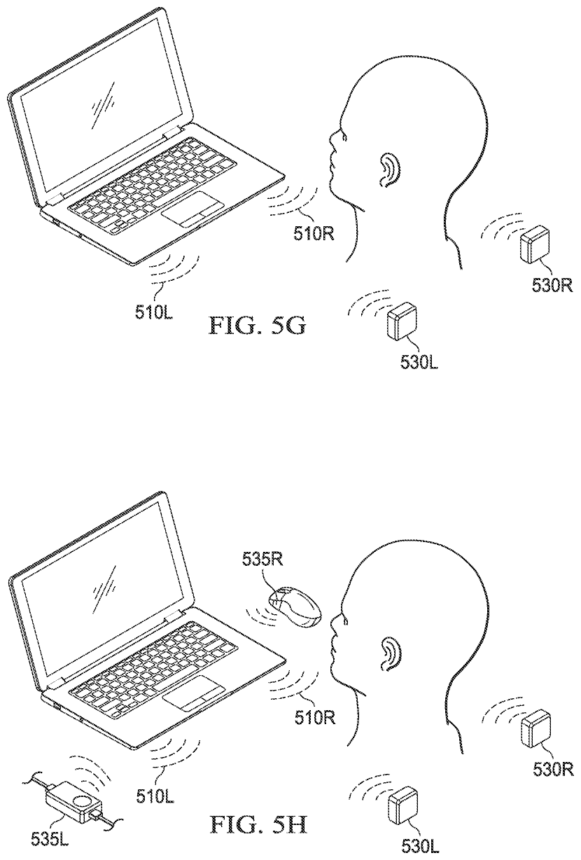

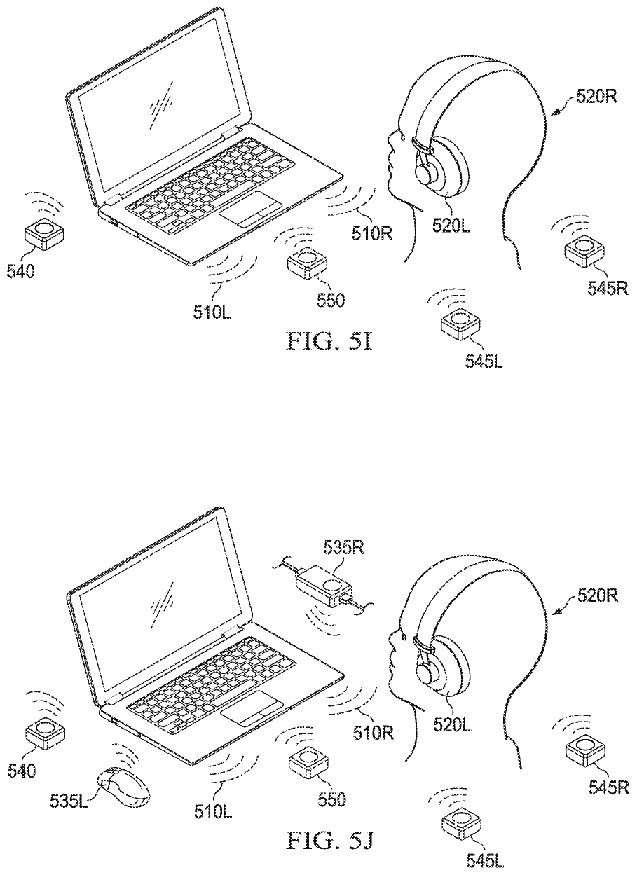

FIGS. 5A-5J show examples of cooperative speaker use. One skilled in the art would recognize that other configurations are possible, and that the positions and types of the speakers shown here are only exemplary.

FIG. 5A shows an example of using internal speakers (510) with an external speaker (505) imbedded in the device's power adapter (506). The adapter (506) is specially configured so that it's connection to the device includes both power and data transfer capability (e.g., USB-C). The power adapter (506) can be placed in a position that allows powering the device while also being useful as a speaker.

FIG. 5B shows an example of using internal speakers (510) with an external speaker (515A) imbedded in a wired mouse (516A) connected to the device. Also possible are other similar external input devices, such as an external trackball, a graphics tablet, joystick, or other controller. While the mouse will move during use, it generally stays in the same general area relative to the user (e.g., front right), so it can still be considered to have a particular location compared to the other speakers for dynamic adjustment purposes.

FIG. 5C shows an example of using internal speakers (510) with an external speaker (515B) imbedded in a wireless mouse (516B) connected to the device, similar to FIG. 5B. The mouse (516B) can receive the audio input using a wireless connection it has with the device, such as Bluetooth, 2.4G, 5G, etc.

FIG. 5D shows an example of using internal speakers (510) with a wired headset (520A). In some embodiments, the headset (520A) is not noise-cancelling allowing the internal speakers (510) to create a surround sound effect with the headphones (520A). In some embodiments, the headset (520A) is noise-cancelling, but is configured to allow sound from the internal (510) and any other external speakers (e.g., the playback audio is not considered “noise” by the headset). These embodiments apply to all use-cases involving headphones.

FIG. 5E shows an example of using internal speakers (510) with a wireless headset (520B), similar to FIG. 5D.

FIG. 5F shows an example of using internal speakers (510) with an external speaker (525). The speaker (525) can be wired or wireless and can be used to augment the surround sound effect and/or can be used to produce the lower frequency tones of the audio. The speaker (525) can be a woofer or a sub-woofer in some embodiments.

FIG. 5G shows an example of using coordinated speakers to create surround sound (e.g., Dolby 4.0 surround). The internal speakers act as the front right (510R) and front left (510L) speakers and the external speakers act as the rear right (530R) and rear left (530L) speakers.

FIG. 5H shows an example of using coordinated speakers to create surround sound (e.g., Dolby 6.0 surround). The internal speakers act as the front right (510R) and front left (510L) speakers and the external speakers act as the rear right (530R) and rear left (530L) speakers. An integrated speaker in the mouse (535R) provides a right-surround speaker and an integrated speaker in the power adapter (535L) provides a left-surround speaker.

FIG. 5I shows an example of using coordinated speakers to create surround sound (e.g., Dolby 5.1.2 channel surround). The internal speakers act as the front right (510R) and front left (510L) speakers and the external speakers act as the rear right (545R) and rear left (545L) speakers. An additional center external speaker (550) is provided as well as an external sub-woofer (540). The system also supports the use of headphones, with right height (520R—hidden from view) and left height (520L) speakers.

FIG. 5J shows an example of using coordinated speakers to create surround sound (e.g., Dolby 7.1.2 channel surround). The setup is similar to FIG. 5I with the addition of integrated mouse (535L) and power adapter (535R) speakers providing left-surround and right-surround sound (here assuming a left-handed mouse user—as with all examples, the left and right sides can be reversed based on the user choice).

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A method for enhancing an audio signal for a device with at least one internal speaker and at least one external speaker, the method comprising:
distributing the audio signal to the at least one internal speaker and the at least one external speaker; and
aligning timestamps for the distributed audio signal such that signals for the at least one internal speaker aligns with signals for the at least one external speaker.

2. The method of claim 1 further comprising detecting locations of each of the at least one external speaker and dynamically adjusting the signals for the at least one external speaker based on the locations.

3. The method of claim 1 further comprising detecting connection statuses of each of the at least one external speakers.

4. The method of claim 1 further comprising multi-channel mixing the audio signal into the at least one internal speaker and the at least one external speaker.

5. The method of claim 1 further comprising configuring crossover of the audio signal.

6. The method of claim 1 further comprising communicating with a wireless speaker of the at least one external speakers in a wireless manner.

7. (canceled)

8. The method of claim 1 further comprising communicating with a wired speaker of the at least one external speaker in a wired manner.

9. (canceled)

10. The method of claim 1 wherein one of the at least one external speakers is integrated into a computer mouse.

11. The method of claim 1 wherein one of the at least one external speakers is integrated into a power adapter of the device.

12. The method of claim 1 wherein one of the at least one external speakers is a headset.

13. The method of claim 2, wherein the detecting locations includes receiving user input on a speaker location.

14. The method of claim 2, wherein the detecting locations includes determining speaker location from an operating system of the device.

15. The method of claim 2, wherein the detecting locations includes using a microphone of the device to determine speaker location.

16. The method of claim 1 wherein the device is one of a laptop computer, a desktop computer, a tablet computer, a smartphone, and a television set.

17. (canceled)

18. A device configured to carry out the method of claim 1.

19. A non-transient computer readable medium comprising data configured to carry out the method of claim 1 when read by a computer.

20. A device comprising:
an audio input;
a microphone;
at least one internal speaker;
at least one connector for external speakers;
a wireless communications module; and
a processor;
wherein the device is configured to:
decode an audio signal from the audio input producing decoded audio;
determine connection statuses of the external speakers both connected to the at least one connector and connected by wireless communications module;
perform cooperative playback control based on the connection statuses;
determine locations of the external speakers both connected to the at least one connector and connected by wireless communications module;
perform dynamic adjustment for the external speakers based on the locations;
perform multi-channel mixing based on the decoded audio, the cooperative playback control, and the dynamic adjustment producing a mixed signal;
perform crossover configuration on the mixed signal producing a crossover signal;
perform signal distribution on the crossover signal among the external speakers and internal speakers producing a distributed signal; and
perform time alignment for the distributed signal for the external speakers and internal speakers.

21. The device of claim 20, wherein the device is any one of a laptop computer, a tablet computer, a desktop computer, or a smartphone.

22. The device of claim 20, wherein the at least one connector comprises a USB connector.

23. The device of claim 20, wherein the wireless communications module comprises a Bluetooth transmitter.
